(19) United States
(12) Patent Application Publication
(10) Pub. No.: US 2015/0237164 A1
(43) Pub. Date: Aug. 20, 2015

(54) IMPROVING OR OPTIMIZING A RADIO HEATMAP VIA FEEDBACK TO AGENTS

(71) Applicant: QUALCOMM Incorporated, San Diego, CA (US)

(72) Inventors: Faraz Mohammad Mirzaei, San Jose, CA (US); Kelvin So, Sunnyvale, CA (US); Saumitra Mohan Das, Santa Clara, CA (US); Ayman Fawzy Naguib, Cupertino, CA (US)

(73) Assignee: QUALCOMM Incorporated, San Diego, CA (US)

(21) Appl. No.: 14/183,359

(22) Filed: Feb. 18, 2014

(51) Int. Cl. H04L 29/06

(52) U.S. Cl. CPC H04L 67/42

(57) ABSTRACT

Example methods, apparatuses, or articles of manufacture are disclosed herein that may be utilized, in whole or in part, to facilitate or support one or more operations or techniques for improving or optimizing a radio heatmap via feedback to one or more agents for use in or with a mobile communication device.

### BACKGROUND

1. Field

The present disclosure relates generally to indoor position or location estimations of mobile communication devices and, more particularly, to improving or optimizing a radio heatmap via feedback to one or more agents.

2. Information

Mobile communication devices, such as, for example, cellular telephones, portable navigation units, laptop computers, personal digital assistants, or the like are becoming more common every day. Certain mobile communication devices, such as, for example, location-aware cellular telephones, smart telephones, or the like may assist users in estimating their geographic locations by providing positioning assistance data obtained or gathered from various systems. For example, in an outdoor environment, certain mobile communication devices may obtain an estimate of their geographic location or so-called “position fix” by acquiring wireless signals from a satellite positioning system (SPS), such as the global positioning system (GPS) or other like Global Navigation Satellite Systems (GNSS), cellular base station, etc. via a cellular telephone or other wireless communications network. Acquired wireless signals may, for example, be processed by or at a mobile communication device, and its location may be estimated using known techniques, such as Advanced Forward Link Trilateration (AFLT), base station identification, or the like.

In an indoor environment, certain mobile communication devices may be unable to reliably receive or acquire satellite or like wireless signals to facilitate or support one or more position estimation techniques. As such, in an indoor environment, different techniques may be employed to enable navigation or location services. For example, at times, an indoor location of a mobile communication device may be estimated via radio heatmap signature matching, for example, in which current characteristics of wireless signals received at the mobile device are compared with expected or previously measured signal characteristics stored as heatmap values in a database. By finding a signature in a database that most closely matches characteristics exhibited by wireless signals received at a mobile device, a location associated with a matching signature may be used as an estimated location of a mobile device. In some instances, however, a process of generating or constructing a radio heatmap may be subject to a number of measurement or processing errors, which may at least partially preclude its use for position estimations.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating an implementation of an example process that may be performed to facilitate or support techniques for improving or optimizing a radio heatmap via feedback to one or more agents.

FIG. 3 is a schematic diagram illustrating an implementation of a client-server communications.

FIG. 4 is a schematic diagram illustrating an implementation of an example computing environment associated with a mobile device.

FIG. 5 is a schematic diagram illustrating an implementation of an example computing environment associated with a server.

### SUMMARY

Example implementations relate to techniques for improving or optimizing a radio heatmap via feedback to one or more agents. In one implementation, a method may comprise collecting, at a mobile device, measurements while traveling over a route or area in a venue, the route or the area being determined according to one or more initial instructions in one or more messages received from a server; transmitting, in response to the one or more initial instructions, one or more messages to the server comprising the collected measurements for use in computing expected signature values at predetermined locations in the venue; and receiving one or more messages from the server comprising one or more updated instructions for collecting measurements while traveling in the venue, the one or more updated instructions being determined based, at least in part, on an analysis of the collected measurements determined at the server.

In another implementation, an apparatus may comprise a mobile device comprising a wireless transceiver to communicate with a server via an electronic communications network; and one or more processors to collect measurements while traveling over a route or area in a venue, the route or the area being determined according to one or more initial instructions in one or more messages received from the server; transmit, in response to the one or more initial instructions, one or more messages to the server comprising the collected measurements for use in computing expected signature values at predetermined locations in the venue; and receive one or more messages from the server comprising one or more updated instructions for collecting measurements while traveling in the venue, the one or more updated instructions being determined based, at least in part, on an analysis of the collected measurements determined at the server.

In yet another implementation, an apparatus may comprise means for collecting, at a mobile device, measurements while traveling over a route or area in a venue, the route or the area being determined according to one or more initial instructions in one or more messages received from a server; means for transmitting, in response to the one or more initial instructions, one or more messages to the server comprising the collected measurements for use in computing expected signature values at predetermined locations in the venue; and means for receiving one or more messages from the server comprising one or more updated instructions for collecting measurements while traveling in the venue, the one or more updated instructions being determined based, at least in part, on an analysis of the collected measurements determined at the server.

In yet another implementation, an article may comprise a non-transitory storage medium having instructions executable by a processor to collect, at a mobile device, measurements while traveling over a route or area in a venue, the route or the area being determined according to one or more initial instructions in one or more messages received from a server; transmit, in response to the one or more initial instructions, one or more messages to the server comprising the collected measurements for use in computing expected signature values at predetermined locations in the venue; and receive one or more messages from the server comprising one or more updated instructions for collecting measurements while traveling in the venue, the one or more updated instructions being determined based, at least in part, on an analysis of the collected measurements determined at the server. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations or techniques for improving or optimizing a radio heatmap via feedback to one or more agents. The terms “agent,” “user,” or “client” may be used interchangeably herein and may refer to a person, device, or application that may facilitate or support a collection, generation, or communication of one or more suitable signal measurements. As discussed below, in some instances, one or more collected, generated, communicated, etc. signal measurements may be used, at least in part, for generating or updating expected signature values in a radio heatmap for an indoor or like environment. At times, to facilitate or support constructing or updating a radio heatmap, one or more crowd-sourcing techniques may, for example, be utilized, in whole or in part. For example, in at least one implementation, a crowd-sourcing user or agent may employ a mobile communication device, at least in part, to collect, generate, communicate, etc. signal measurements while traveling over a particular route or area in an indoor or like environment in response to one or more instructions or indications (e.g., audible, visual, sound, etc. commands) presented to the user on a user interface of the device, as will also be seen.

As used herein, “mobile device,” “mobile communication device,” “wireless device,” “location-aware mobile device,” or the plural form of such terms may be used interchangeably and may refer to any kind of special purpose computing platform or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, radio heatmap generation tools, or the like. It should be appreciated, however, that these are merely examples of mobile devices that may be used, at least in part, to implement one or more operations or techniques for improving or optimizing a radio heatmap via feedback to one or more agents, and that claimed subject matter is not limited in this regard. It should also be noted that the terms “position” and “location” may be used interchangeably herein.

As alluded to previously, in an indoor environment or like partially or substantially enclosed area (e.g., an urban canyon, etc.), certain mobile devices may be unable to reliably receive or acquire satellite or like wireless signals to facilitate or support one or more position estimation techniques. For example, signals from an SPS or other wireless transmitters may be attenuated or otherwise affected in some manner (e.g., insufficient, weak, fragmentary, blocked, etc.), which may at least partially preclude their use for position estimations. As such, in an indoor or like environment, such as in a venue of interest, for example, different techniques may be employed to enable navigation or location services. For example, a mobile device may obtain an indoor position fix by measuring ranges to three or more terrestrial wireless access points positioned at known locations within a venue, just to illustrate one possible implementation. Ranges may be measured, for example, by obtaining a Media Access Control identifier (MAC ID) address from wireless signals received from wireless transmitters (e.g., access points, etc.) and measuring one or more characteristics of received signals, such as signal strength, round trip delay, or the like.

As used herein, “venue” may refer to a physical place or locale that may be associated with the whereabouts of an object or thing (e.g., a user, mobile device, etc.) according to a suitable point of reference. A point of reference may, for example, be represented via geographic coordinates (e.g., latitude, longitude, etc.), a street address, governmental jurisdiction, postal zip code, name, number, or the like. Optionally or alternatively, a venue may also include references to altitude, time, direction, distance (e.g., from another point of reference, etc.), or the like. In some instances, a venue may comprise, for example, a partially or substantially enclosed indoor or like area, such as associated with an indoor environment (e.g., a building, area within a building, etc.), outdoor environment (e.g., urban canyons, etc.), or any combination thereof. By way of example but not limitation, a venue may include, for example, an office building, a convention center, an auditorium, an amphitheater, a warehouse, a classroom building, a theater, a supermarket, a shopping mall, a sports arena, a stadium, a transit station terminal, a library, or the like. Again, these are merely examples, and claimed subject matter is not so limited.

As was also indicated, at times, an indoor location of a mobile device may be estimated via radio heatmap signature matching, for example, in which current or live characteristics or signatures of wireless signals received at the mobile device are compared with expected or previously measured signal characteristics stored as radio heatmap values in a database. Typically, such as during an off-line stage, a particular indoor or like area (e.g., in a venue, etc.) may be surveyed, for example, and radio heatmap values, such as in the form of observed characteristics of wireless signals or so-called signal “signatures” indicative of received signal strength (e.g., RSSI, etc.), round-trip delay times (e.g., RTT, etc.), or the like may be collected. During an on-line stage, a mobile device may, for example, communicate currently observed or live signal signatures to a suitable server for matching with previously measured signal characteristics. By finding a signal signature in a database that more closely matches characteristics exhibited by signals currently observed at a mobile device, a location associated with a matching signature may, for example, be used as an estimated location of the mobile device.

In some instances, a radio heatmap constructed for a particular indoor or like area may, for example, be selectively provided or otherwise made available to a mobile device by an indoor navigation system, location server, etc. as part of positioning assistance data. A radio heatmap may, for example, be provided in the form of heatmap values or like metadata representing observed characteristics of wireless signals (e.g., RSSI, RTT, etc.) at particular locations in an area. A radio heatmap may be defined by a grid of points laid over or mapped to a floor plan or layout of an indoor or like area at relatively uniform spacing (e.g., two-meter separation of neighboring grid points, etc.), for example, and representing expected signal signatures at these points. Thus, for a known wireless transmitter, a radio heatmap may, for example, associate a particular grid point with a heatmap value representative of an expected signal signature at the grid point. As such, heatmap values associated with one or more known access points may, for example, enable a mobile device to correlate or associate observed signal signatures with locations within an indoor or like area of interest.

At times, instead of or in addition to a radio heatmap, an indoor navigation system, location server, etc. may selectively provide or otherwise make available (e.g., to a mobile device, etc.) other suitable positioning assistance data, which may include, for example, an electronic digital map for a venue of interest. An electronic digital map may, for example, be provided by a suitable server at or upon entering a particular indoor or like area (e.g., a shopping mall, etc.), upon request, user input, or the like. An electronic digital map may include, for example, a floor plan or layout comprising indoor features of a venue or an area within a venue, such as doors, hallways, staircases, elevators, walls, etc., as well as points of interest (POIs), such as restrooms, stores, rooms, entry ways, pay phones, or the like. In some instances, an electronic digital map may, for example, be stored at a suitable server to be accessible or useable by a mobile device, such as via a selection or activation of a Uniform Resource Locator (URL), for example. By having a digital map of a venue or area of interest, a mobile device may, for example, be capable of overlaying its current location over the displayed map of the venue or area so as to provide an associated user with additional context, frame of reference, or the like.

At times, to facilitate or support localization via measurements of ranges to wireless transmitters (e.g., access points, etc.) positioned within a venue, for example, it may be useful to have a relatively comprehensive or otherwise sufficient knowledge of an associated radio heatmap. As was indicated, an extensive site survey may present a number of challenges, such as, for example, simulation or computation costs, time or effort involved, or the like. Thus, in some instances, such as to reduce associated costs, for example, a radio heatmap may be constructed or generated, at least in part, from relatively noisy or cheaply collected measurements. For example, measurements for a radio heatmap may be collected, generated, communicated, etc. by crowd-sourcing volunteers or other non-experts, rather than professionals with a higher level of skill or designated equipment. Despite relatively lower generation or construction costs, localization capabilities of such a radio heatmap, however, may be less useful or possibly faulty. For example, at times, a “ground truth” measurement or “ground truth” location within a venue may be subject to a human or mobile device-related error. In this context, a “ground truth” measurement may generally refer to a signal measurement physically collected or observed at a particular location, such as via crowd-sourcing, for example, rather than via a remote sensing. The term “ground truth” location may generally refer to a mapped location that may correlate or correspond to a location of a physically collected or observed signal measurement, such as a “ground truth” measurement, for example. As a way of illustration, a grid of points laid over or mapped to a floor plan of an indoor or like area of interest at which signal measurements are physically collected or observed may comprise “ground truth” locations, as one possible example.

Another challenge may be that relatively noisy, crowd-sourced, etc. “ground truth” measurements may be inadequate or less than useful due, at least in part, to an insufficient number of “visible” wireless transmitters in an area during data collection. For example, since crowd-sourcing is typically carried out at a user's convenience and since data collection times may vary, certain wireless transmitters may be turned off, moved, shielded, rendered inoperable, etc. during crowd-sourcing. In addition, at times, hardware or software hosted on a utilized mobile device may have a defect or flaw, for example, which may cause an incorrect or undesired “ground truth” measurement, correlate or correspond to an imprecise or wrong “ground truth” location, or the like. This may, for example, decrease or affect in some manner utility or effectiveness of a generated radio heatmap, localization accuracy of associated mobile devices, or the like. Accordingly, it may be desirable to develop one or more methods, systems, or apparatuses that may implement more effective or efficient indoor positioning, such as in connection with a radio heatmap, for example, while reducing or improving uncertainty or unreliability inherent in crowd-sourced “ground truth” measurements “ or in pairing collected measurements with ground truth” locations.

Thus, as described below, in an implementation, a suitable process or entity, such as a venue operator operating or otherwise having access to a server for a venue of interest, for example, may provide an incentive to users with mobile devices for assistance in collecting signal measurements paired or correlated with “ground-truth” locations for use in constructing or updating a radio heatmap. For example, as was indicated, certain location-aware mobile devices may have a capability to approximate “ground truth” locations in an indoor or like area where a signal measurement may be made in connection with one or more proximate wireless transmitters (e.g., “ground truth” measurements, etc.). Here, one or more of suitable techniques, such as, for example, applying trilateration to measurements of ranges to transmitters at fixed locations using signal signatures (e.g., RSSI, RTT, etc.), receiving a user input at a user interface, applying dead-reckoning measurements from inertial or motion sensors (e.g., from a known starting position), etc. may be used, in whole or in part. Claimed subject matter is not limited to a particular technique, of course. For example, in some instances, “ground truth” locations may be approximated by providing certain “landmarks” or cues to users with mobile devices, such as visually on an associated screen or display, via haptic or sound technology, or the like. As a way of illustration, a user may, for example, be asked (e.g., visually via a provided electronic digital map, etc.) to collect measurements “alongside the wall on the right side of the entrance to Macy's®.” Again, claimed subject matter is not limited in this regard. Based, at least in part, on collected measurements, such as paired or correlated with “ground-truth” locations, for example, one or more participating users may be rewarded in some manner, as will also be seen.

At times, a venue operator may provide, such as via a server-client-type communication, for example, one or more messages to users of mobile devices with one or more instructions or indications of a route or area in the venue (e.g., a particular wing, floor, hallway, etc.) where measurements may be desired. In some instances, instructions or indications may comprise, for example, visual-type instructions displayed on a screen or display of an associated mobile device. For example, a visual-type instruction or indication may be in the form of a displayed route or area overlaid over an electronic digital map with a floor plan or layout of a venue (or a part thereof) so as to direct a user to collect measurements while traveling over such a route or area. Claimed subject matter is not so limited, of course. For example, at times, as discussed below, instead of or in addition to a visual-type instruction or indication, a haptic-type instruction or indication, sound-type instruction or indication, etc., or any combination thereof may be employed, at least in part, for collecting signal measurements. In some instances, one or more messages to users of mobile devices with instructions or indications may include, for example, a type of a signal characteristic for a user to measure (e.g., RSSI, RTT, etc.), such as within a particular venue, area, route, etc. For example, at times, a user may select an RSSI as an applicable signal characteristic to be collected, generated, communicated, etc., such as via a user interface of an associated mobile device, just to illustrate one possible implementation.

At times, participating users may communicate collected measurements to a suitable server (via a push, pull, etc. technology) and may receive monetary or non-monetary rewards, such as coupons, loyalty points, discounts, credits, payouts, etc., or any combination thereof in exchange for completion of specific tasks. Tasks may include, for example, collecting, communicating, etc. signal measurements (e.g., RSSI, RTT, etc.) while traveling over a specific route or area identified via one or more provided messages. Collected measurements may be combined in a suitable manner, such as at a server for a particular venue, for example, and may be used, at least in part, to generate, construct, or update an associated radio heatmap. In some instances, such as if collected measurements for one or more routes or areas in a venue may be inadequate, insufficient, erroneous, suspicious, etc., a venue operator may, for example, selectively provide updated instructions or indications to a user of a mobile device to collect new, different, or separate measurements for these routes or areas. Updated instructions may be provided based, at least in part, on an analysis of previously collected signal measurements, such as used in constructing a radio heatmap, for example, just to illustrate one possible implementation. In analyzing collected measurements, a server may use any one of several techniques such as, for example, applying a clustering algorithm to identify suspicious or erroneous measurements, examining a spatial correlation between areas of measured signal signatures, or the like. In some instances, an analysis of signal measurements may be performed or determined, at least in part, at a mobile device or any combination of a server and mobile device.

As a way of illustration, in the context of a shopping mall, initial instructions may, for example, be provided to a user of a mobile device via an electronic digital map displayed on a user interface and having a floor plan or layout of the mall, particular wing or corridor of the mall, or any portion thereof. In some instances, a displayed map may indicate or specify a suggested path or trajectory, such as within a wing or corridor, for example, for a user to travel while collecting signal measurements. For example, at times, a suggested path or trajectory may be specified via one or more directional arrows overlaying a wing or corridor so as to indicate a measurement path or trajectory, direction of travel, etc., just to illustrate one possible implementation. Of course, claimed subject matter is not so limited. For example, a path or trajectory, direction of travel, etc. may be specified via a start and end points (e.g., Start of Route-End of Route, Point A-Point B, etc.) or in any other suitable manner.

In an implementation, a measurement path or trajectory may, for example, be color-coded in some manner so as to differentiate between more or less desirable routes or areas for collecting, generating, communicating, etc. signal measurements (e.g., a green path is more desirable, yellow is less desirable, etc.). Optionally or alternatively, a path or trajectory may, for example, be specified via a displayed list of available paths or trajectories, which may be color-coded, ranked, etc. so as to indicate more or less desirable measurement routes or areas. In some instances, one or more rewards for collecting signal measurements may also be displayed in an electronic digital map in a suitable manner (e.g., via icons, text, next to POIs, etc.) so as to let a user know in advance what coupons, loyalty points, discounts, credits, payouts, etc. may be earned or attained upon completion of specific tasks. A level of rewards may also be route or area-dependent, for example (e.g., color-coded, etc.).

At times, signal measurements may be collected in connection with a suitable host application that may be provided by any suitable resource, such as a venue operator, for example, and may be downloaded, activated, launched, etc. upon user's entering a venue (or particular area therein), upon request, user input, or the like. Collected measurements may, for example, be communicated to a suitable server in real time or near real time. In this context, “real time” may refer to an amount of timeliness of content, which may have been delayed by an amount of time attributable to electronic communication as well as other signal processing. In some instances, measurements may be collected on a mobile device, and a venue operator may, for example, extract collected measurements from a memory of the mobile device (e.g., via a pull technology, etc.), such as with permission from their users, if applicable. Of course, these are merely examples relating to communication of collected measurements, and claimed subject matter is not so limited.

As was indicated, based, at least in part, on an analysis of collected measurements (e.g., to identify suspicious, erroneous, etc. measurements), a venue operator may, for example, provide feedback to one or more crowd-sourcing users. For example, at times, feedback may be in the form of updated instructions or indications (e.g., audible, visual, sound, etc. commands) in a message communicated from a suitable server and displayed, played, etc. to a user. Feedback may, for example, instruct a user to commence collecting measurements in a different portion of a venue, recollect measurements in the same portion of a venue, change direction of travel while collecting measurements, or the like. In some instances, updated instructions may also be color-coded, for example, so as to provide for a higher or different level of incentives or rewards (e.g., may be route or area-dependent, etc.), such as in comparison to rewards offered in connection with initial instructions. For example, if a user, in response to updated instructions, opts to collect (or recollect) measurements in an area (e.g., more desirable, etc.) with insufficient radio heatmap coverage, erroneous or suspicious measurements, etc., the user may be rewarded with a bigger discount, more loyalty points, higher payout, etc.

At times, measurements collected in response to updated instructions may be communicated to a suitable server (e.g., via a push, pull technology, etc.), and one or more inadequate, insufficient, erroneous, suspicious, etc. signal signatures may be corrected or updated, such as to improve or optimize an associated radio heatmap, for example. As such, at least partially erroneous, incomplete, uncertain, unreliable, etc. radio heatmaps may be timely detected or flagged, for example, and one or more associated inadequate, erroneous, etc. heatmap values may be discarded or otherwise prevented from being utilized, such as in connection with obtaining a position fix. Thus, feedback to one or more crowd-sourcing users may, for example, facilitate or support more effective of efficient radio heatmap generation or updating as well as correlation of “ground truth” measurements with “ground truth” locations within an indoor or like environment, such as a venue.

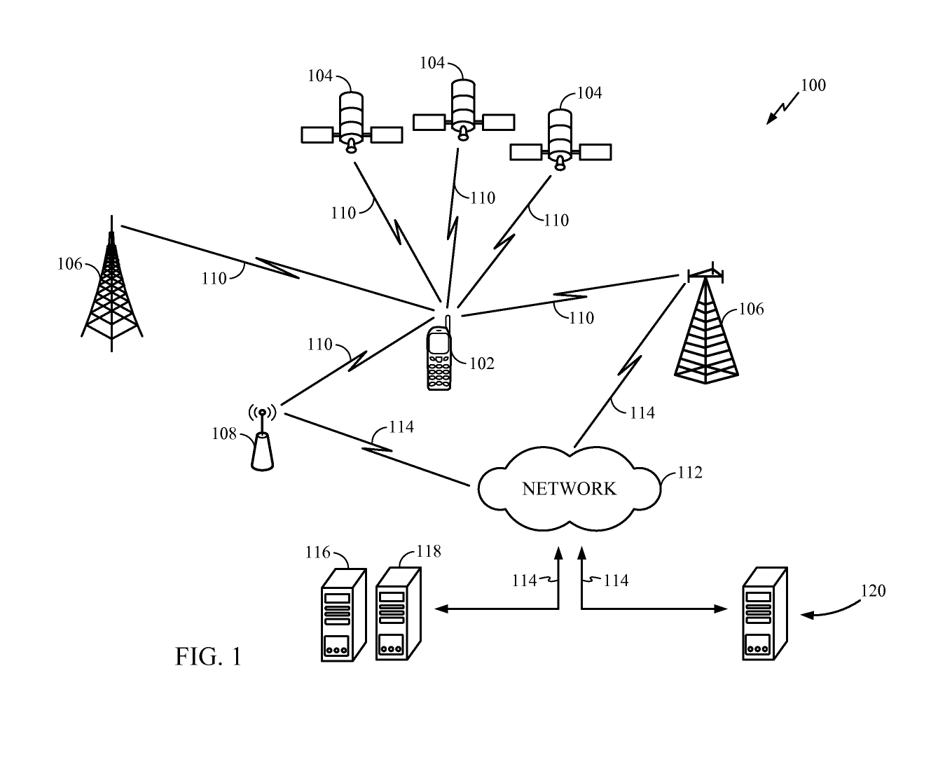

FIG. 1 is a schematic diagram illustrating features associated with an implementation of an example operating environment 100 capable of facilitating or supporting one or more processes or operations for improving or optimizing a radio heatmap via feedback to one or more agents. It should be appreciated that operating environment 100 is described herein as a non-limiting example that may be implemented, in whole or in part, in the context of various electronic communications networks or combination of such networks, such as public networks (e.g., the Internet, the World Wide Web), private networks (e.g., intranets), wireless local area networks (WLAN, etc.), or the like. It should also be noted that claimed subject matter is not limited to indoor implementations. For example, at times, one or more operations or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations or techniques described herein may be performed, at least in part, in an outdoor environment.

As illustrated, operating environment 100 may comprise, for example, one or more satellites 104, base transceiver stations 106, wireless transmitters 108, etc. capable of communicating with mobile device 102 via communication links 110 in accordance with one or more communication protocols. Satellites 104 may be associated with one or more satellite positioning systems (SPS), such as, for example, the United States Global Positioning System (GPS), the Russian GLONASS system, the European Galileo system, as well as any system that may utilize satellites from a combination of satellite systems, or any satellite system developed in the future. For example, satellites 104 may be from any one of several regional navigation satellite systems (RNSS′) such as the Wide Area Augmentation System (WAAS), European Geostationary Navigation Overlay Service (EGNOS), Quasi-Zenith Satellite System (QZSS), etc. Base transceiver stations 106, wireless transmitters 108, etc. may be of the same or similar type, for example, or may represent different types of devices, such as access points, radio beacons, cellular base stations, femtocells, or the like, depending on an implementation.

Although not shown, in some instances, operating environment 100 may include, for example, a larger number of wireless transmitters 108 that may be associated with an indoor or like area of interest, such as a venue. A larger number of wireless transmitters 108 may correspond to or correlate with a radio heatmap, for example. It should be noted that one or more wireless transmitters 108 may be capable of transmitting as well as receiving wireless signals. In a particular implementation, one or more wireless transmitters 108 may be capable of communicating with mobile device 102 at a shorter range than at a range enabled by base transceiver station 106. For example, one or more wireless transmitters 108 may be positioned in an indoor or like environment, such as a venue, as was indicated. One or more wireless transmitters 108 may, for example, provide access to a wireless local area network (WLAN, e.g., IEEE std. 802.11 network, etc.) or wireless personal area network (WPAN, e.g., Bluetooth® network, etc.). In another example implementation, one or more wireless transmitters 108 may comprise, for example, a femtocell transceiver capable of facilitating or supporting communication within operating environment 100 according to a cellular communication protocol.

In some instances, one or more base transceiver stations 106, wireless transmitters 108, etc. may, for example, be operatively coupled to an electronic communications network 112 that may comprise one or more wired or wireless communications or computing networks capable of providing suitable information, such as via one or more communication links 114, 110, etc. As will be seen, provided information may include, for example, positioning assistance data, such as a radio heatmap, recent position fix obtained via an SPS, one or more messages with instructions or indications for collecting signal measurements, feedback to crowd-sourcing users, collected signal measurements, rewards, or the like. At times, provided information may include, for example, locations of one or more wireless transmitters 108, an electronic digital map, suggested path for a route or area, etc. to facilitate or support one or more operations or processes associated with operating environment 100. Positioning assistance data may, for example, be provided in the form of an audio, video, or sound file, look-up table, mathematical formula, algorithm, metadata, etc., which may depend, at least in part, on an application, network, environment, radio heatmap, mobile device, or the like.

In an implementation, network 112 may be capable of facilitating or supporting communications between suitable computing platforms or devices, such as, for example, mobile device 102, one or more base transceiver stations 106, wireless transmitters 108, as well as one or more servers associated with operating environment 100. In some instances, servers may include, for example, a location server 116, positioning assistance server 118, as well as one or more other servers, indicated generally at 120 (e.g., navigation, information, map, etc. server, etc.), capable of facilitating or supporting one or more operations or processes associated with operating environment 100. In a particular implementation, network 112 may comprise, for example, Internet Protocol (IP) infrastructure capable of facilitating a communication between mobile device 102 and servers 116, 118, or 120 via wireless transmitter 108, base transceiver station 106 (e.g., via a network interface, etc.), or the like. In another implementation, network 112 may comprise cellular communication network infrastructure, such as, for example, a base station controller or master switching center (not shown) to facilitate mobile cellular communication with mobile device 102.

Location server 116 may provide an estimate of a coarse location of mobile device 102 within a venue of interest associated with operating environment 100, such as at or upon entry of the venue, for example. A coarse location may, for example, be determined based, at least in part, on last or recent position fix obtained via an SPS, input provided by an associated user, or the like. For example, at times, a coarse location of mobile device 102 may be determined using a proximity to one or more reference points, such as by knowing which wireless transmitter 108, etc. mobile device 102 is using at a given time. In some instances, mobile device 102 may utilize its coarse location, in whole or in part, in subsequent messages with a suitable server, such as servers 116, 118, or 120, for example, to obtain an electronic digital map or other information relevant to an area in a venue identified by a coarse location (e.g., a routing graph, etc.). Optionally or alternatively, a coarse location of mobile device 102 may, for example, be determined, at least in part, on mobile device 102 using one or more applicable techniques (e.g., dead reckoning, etc.). In some instances, such as in addition to or instead of determining a coarse location via one or more applicable approaches, for example, mobile device 102 may communicate MAC addresses of one or more known (e.g., visible, etc.) wireless transmitters 108, etc. to a suitable server, and may be provided an electronic digital map of an associated area. Mobile device 102 may, for example, estimate its location based, at least in part, on provided map and known wireless transmitters 108, etc. using one or more appropriate techniques.

Positioning assistance server 118 may, for example, provide positioning assistance data, such as locations of one or more wireless transmitters 108, a radio heatmap, signal signatures, or the like. For example, positioning assistance server 118 may provide locations of one or more wireless transmitters 108 via a suitable reference frame, such as (X, Y, Z) coordinates in three-dimensional Cartesian coordinate space that may or may not be mapped according to a global coordinate system, just to illustrate one possible implementation. Of course, claimed subject matter is not limited to a particular reference frame or positioning assistance data.

In some instances, server 120 may comprise a map server, for example, and may provide an electronic digital map as well as other positioning assistance data or like information for a particular indoor or like area of interest, such as a venue. An electronic digital map may comprise, for example, a floor plan or layout of a venue or a portion thereof. By way of non-limiting example, an electronic digital map may include one or more computer-aided design (CAD) type files identifying structural features of a venue, such as walls, rooms, doors, passageways, elevators, staircases, ladders, floors, ceilings, or the like. At times, an electronic digital map may comprise, for example, locations of one or more wireless transmitters 108, etc. relative to structural features (e.g., walls, doors, windows, etc.), composition or type of structural features (e.g., walls, doors, windows, etc.), or the like. For example, in some instances, such as at or upon entry of a venue of interest, upon user input, etc., mobile device 102 may communicate a request to server 120 (e.g., a map server, etc.) to provide an electronic digital map covering the venue, a portion thereof, or adjacent areas, if applicable. A request may reference or otherwise include, for example, a coarse location of mobile device 102, as was indicated, such that server 120 (e.g., a map server, etc.) may associate the coarse location of mobile device 102 with a particular area in a venue, and then communicate a relevant map to mobile device 102. As discussed below, an electronic digital map may, for example, be used, at least in part, to collect signal measurements while traveling over a route or area in a venue, such as in connection with an overlaid path or trajectory, as one possible example.

According to an embodiment, mobile device 102 may access or obtain suitable positioning assistance data via communications with servers 116, 118, or 120 by, for example, requesting the data through selection of a universal resource locator (URL), as previously mentioned. The terms “positioning assistance data” and “indoor navigation assistance data” may be used interchangeably herein and may include any suitable information to facilitate or support one or more techniques or processes discussed herein. In particular implementations, servers 116, 118, or 120 may be capable of providing indoor navigation assistance data to cover many different indoor areas in a venue including, for example, floors of buildings, wings of hospitals, terminals at an airport, portions of a university campus, areas of a large shopping mall, just to name a few examples. At times, memory resources at mobile device 102 and data transmission resources may make receipt of indoor navigation assistance data for all areas served by servers 116, 118, or 120 impractical or infeasible; thus, a request for indoor navigation assistance data from mobile device 102 may indicate a course estimate of a location of mobile device 102, as was indicated. Mobile device 102 may then be provided indoor navigation assistance data covering areas proximate to a course estimate of a location of mobile device 102. Optionally or alternatively, MAC addresses of one or more known (e.g., visible, etc.) wireless transmitters 108, etc. may, for example, be communicated by mobile device 102 to a suitable server, such as for current location determination, as was also discussed.

In particular implementations and as discussed herein, mobile device 102 may have circuitry and processing resources capable of measuring, storing, or communicating suitable signal characteristics (e.g., RSSI, RTT, etc.), computing a position fix, or the like. For example, mobile device 102 may compute a position fix based, at least in part, on pseudorange measurements to four or more SPS satellites 104. Here, mobile device 102 may compute such pseudorange measurements based, at least in part, on pseudonoise code phase detections in signals 110 acquired from four or more SPS satellites 104, for example. In particular implementations, mobile device 102 may receive from servers 116, 118, or 120 positioning assistance data to aid in the acquisition of signals transmitted by SPS satellites 104 including, for example, almanac, ephemeris data, Doppler search windows, just to name a few examples.

In other implementations, mobile device 102 may, for example, obtain a position fix by processing signals received from one or more terrestrial wireless transmitters positioned at known fixed locations (e.g., wireless transmitter 108, base transceiver station 106, etc.) using any one of several techniques such as, for example, advanced forward trilateration (AFLT), observed time difference of arrival (OTDOA), or the like. In these particular techniques, a range from mobile device 102 may be measured to three or more of such transmitters based, at least in part, on pilot signals transmitted by the transmitters and received at mobile device 102. In some instances, locations or identities of one or more base transceiver stations 106, wireless transmitters 108, etc. in a particular area or areas associated with operating environment 100 may be provided by servers 116, 118, or 120 in the form of a base station almanac (BSA).

As was indicated, in some instances, mobile device 102 may be capable of computing a position fix based, at least in part, on signals acquired from one or more terrestrial wireless transmitters 108 (e.g., WLAN access points positioned at known locations, etc.). For example, mobile devices may obtain a position fix by measuring ranges to three or more indoor terrestrial wireless access points positioned at known locations. Ranges may be measured, for example, by obtaining a MAC ID address from signals received from access points and obtaining range measurements to these access points by measuring one or more received signal characteristics (e.g., RSSI, RTT, etc.). In at least one implementation, mobile device 102 may obtain a position fix by measuring or applying characteristics of acquired signals to a radio heatmap indicating expected RSSI, RTT, or like signatures at particular locations in a venue. In particular implementations, a radio heatmap may associate identities of one or more wireless transmitters 108 (e.g., a MAC address, which is discernible from a signal acquired from a local transmitter, etc.), expected RSSI from signals transmitted by the identified local transmitters, an expected RTT from the identified transmitters, means or standard deviations from these expected RSSI, RTT, etc. It should be understood, however, that these are merely examples of a radio heatmap, and that claimed subject matter is not limited in this respect.

Even though a certain number of computing platforms or devices are illustrated herein, any number of suitable computing platforms or devices may be implemented to facilitate or otherwise support one or more techniques or processes associated with operating environment 100. For example, at times, network 112 may be coupled to one or more wired or wireless communications networks (e.g., Wi-Fi, etc.) so as to enhance a coverage area for communications with mobile device 102, one or more base transceiver stations 106, wireless transmitters 108, servers 116, 118, 120, or the like. In some instances, network 112 may facilitate or support femtocell-based operative regions of coverage, for example. Again, these are merely example implementations, and claimed subject matter is not limited in this regard.

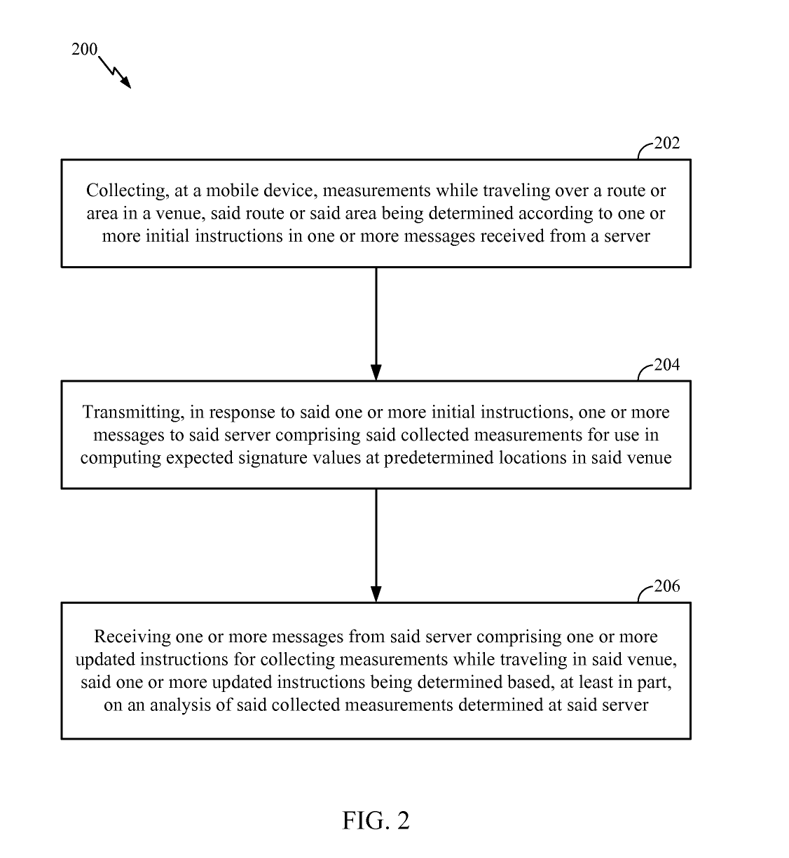

With this in mind, attention is now drawn to FIG. 2, which is a flow diagram illustrating an implementation of an example process 200 that may be performed, in whole or in part, to facilitate or support one or more operations or techniques for improving or optimizing a radio heatmap via feedback to one or more agents that may utilize a mobile device, such as mobile device 102 of FIG. 1, for example. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

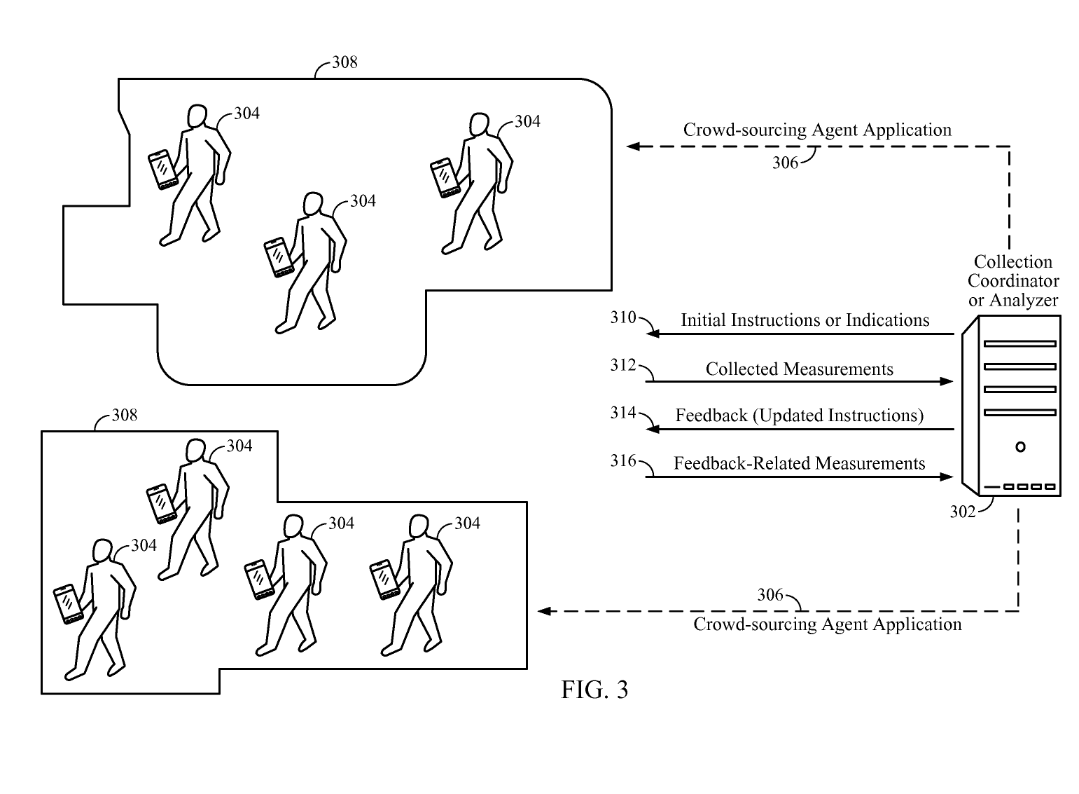

Example process 200 may, for example, begin at operation 202 with collecting, at a mobile device, measurements while traveling over a route or area in a venue, the route or the area being determined according to instructions in one or more messages received from a server. As was indicated, measurements may, for example, be collected with respect to RSSI, RTT, or like characteristics of wireless signals paired with “ground truth” locations within a venue of interest and may be used, at least in part, to generate or update an associated radio heatmap. Signal measurements may, for example, be collected, stored, communicated, etc. in connection with a suitable host application, which may be downloaded to a user's mobile device from a server or stored locally on a mobile device. For example, as illustrated via a schematic diagram 300 of FIG. 3, at times, a suitable server on a network, such as a Collection Coordinator or Analyzer 302 operated by a venue operator, for example, may communicate with one or more crowd-sourcing users or agents 304 with co-located mobile devices to download an appropriate application, as indicated generally via a dashed arrow at 306. Optionally or alternatively, an application may be downloaded via accessing any suitable resource, such as Qualcomm® Vuforia™, iTunes® Application Store (e.g., for an iPhone®, etc.), or the like. An application may, for example, be activated, launched, downloaded, etc. upon user's entering a venue 308 (or any portion thereof), upon request, user input, or the like, as was also indicated.

As illustrated generally via an arrow at 310, in an implementation, server 302 may, for example, provide to one or more users 304 with co-located mobile devices suitable positioning assistance data, such as one or more messages with initial instructions or indications of a route or area in a venue (e.g., a particular wing, floor, hallway, etc.) where measurements may be desired. As discussed above, one or more instructions or indications may be provided in connection with a displayable electronic digital map comprising, for example, a floor plan or layout of venue 308 (or any portion thereof) indicating or specifying one or more measurement routes or areas, paths or trajectories, corresponding rewards, etc. Instructions or indications may comprise, for example, a visual-type instruction or indication, a haptic-type instruction or indication, sound-type instruction or indication, etc., or any combination thereof. For example, instead of or in addition to a visual-type instruction or indication discussed above, at times, an instruction or indication may be provided to one or more users 304 using haptic technology, such as in the form of tactile signals. Tactile signals may include, for example, vibrations, shaking, or like motions perceptible by touch, such as to convey or indicate that one or more users 304 may be in a sufficiently close proximity to a route or area where measurements may be desired, just to illustrate one possible implementation. In some instances, an instruction or indication may be conveyed utilizing any suitable or desired sound alerts, such as beeping, playing music, ringing a bell, etc. so as to indicate a nearby measurement route or area, for example. Of course, these are merely examples of instructions or indications that may be used, at least in part, and claimed subject matter is not so limited. Any other suitable types of instructions or indications may be used herein, in whole or in part.

Referring back to process 200 of FIG. 2, at operation 204, one or more messages may, for example, be transmitted to the server comprising the collected measurements for use in computing expected signature values at predetermined locations in the venue. As alluded to previously, expected signature values at predetermined locations in a venue, such as paired with “ground truth” locations, for example, may be used, at least in part, in constructing or updating a radio heatmap. As used herein, “predetermined location” may refer to a location associated with a stored signal pattern of one or more characteristics or values of one or more wireless signals received at or obtained by a mobile device. In some instances, a predetermined location may comprise, for example, any suitable measurement location. Thus, as discussed above, at times, a predetermined location may comprise, for example, a “ground truth” location within an indoor or like environment, such as a venue of interest.

Continuing now with FIG. 3, in an implementation, in response to one or more initial instructions or indications, one or more users 304 with co-located mobile devices may, for example, transmit one or more messages to server 302, as illustrated generally via an arrow at 312. Messages transmitted by one or more users 304 may include, for example, signal measurements collected while traveling over a specific route or area within venue 308, identification of that specific route or area, or any other suitable information, such as a user ID, mobile device ID, time of data collection, specifics of a collection task, or the like. Optionally or alternatively, one or more messages or suitable information may be extracted from a memory of a collecting mobile device by a venue operator, such as with permission from one or more users 304, for example, as was indicated. Signal measurements may be collected or stored, in whole or in part, on server 302, mobile device, etc., or any combination thereof, such as with reference to a user or mobile device ID, for example. Having completed a specific task, such as collecting, communicating, etc. signal measurements while traveling over one or, at times, a plurality of initial routes or areas, for example, one or more users 304 may receive one or more appropriate monetary or non-monetary rewards (e.g., coupons, loyalty points, discounts, credits, payouts, etc.), as discussed above. As was also indicated, collected measurements may be combined in a suitable manner, such as at server 302, for example, and may be used, at least in part, to generate, construct, or update an associated radio heatmap. Here, any suitable interpolation, regression, or other methods or approaches for constructing a radio heatmap, such as linear interpolation, spline interpolation, least squares regression, Gaussian process regression, or the like may be used, in whole or in part.

Referring back to process 200 of FIG. 2, at operation 206, one or more messages may, for example, be received from the server, the one or more messages comprising one or more updated instructions for collecting measurements while traveling in the venue, the one or more updated instructions being determined based, at least in part, on an analysis of the collected measurements determined at the server. For example, in an implementation, based, at least in part, on signal measurements received in one or more messages from one or more participating users, a suitable server may analyze the received measurements. For example, as discussed below, in some instances, collected measurements may be analyzed in connection with one or more expected signal signature values in a generated or constructed radio heatmap. In analyzing collected measurements, a server may use any one of several techniques such as, for example, applying clustering algorithm to identify suspicious or erroneous measurements, examining spatial correlation between areas of measured signal signatures, or the like.

For example, at times, a suitable clustering algorithm, such as k-means clustering, may be used, at least in part, to cluster collected measurements associated with a radio heatmap and obtained from a specific wireless transmitter (e.g., an access point, etc.) positioned at a known location within a venue. More specifically, centroids of at least two clusters of measurements collected from a wireless transmitter may be computed, such as by weighted average of individual measurements based on their RSSI, RTT, or other applicable characteristics, for example. Distance between centroids of clusters may, for example, be computed based, at least in part, on a highest or otherwise suitable signal signature value of an applicable wireless characteristic (e.g., RSSI, RTT, etc.) measured in each cluster. If a distance between centroids of clusters is greater than some radio signal propagation threshold, a dataset comprising a radio heatmap or any portion thereof associated with these clusters may be flagged as erroneous or suspicious. A radio signal propagation threshold may be determined, at least in part, experimentally and may be pre-defined, for example, or otherwise dynamically defined in some manner depending on a particular environment, radio heatmap, venue, application, or the like. By way of example but not limitation, a threshold may be pre-defined as a reference cut-off value at which it may not be feasible or suitable for appropriate radio signals to propagate between clusters based, at least in part, on physical geometry of a venue's propagation space, radio channel propagation characteristics, or the like. To illustrate, if there is no gradual or discernible signal attenuation or observable decay (e.g., a signal is continually strong, etc.) between two measurement clusters despite an increase in distance from clusters to a reference wireless transmitter, respective signal measurements may be flagged as unreliable. It should be noted that in some instances, collected signal measurements may, for example, be filtered, such as before clustering. For example, all or some RSSIs weaker than −70 decibel (dB) may be discarded, and clustering may then be performed, at least in part, on one or more remaining measurements.

Thus, spatial correlation between suspicious, uncertain, etc. areas of measured signal signatures may be analyzed or examined, such as, for example, to determine if an associated radio heatmap is unrealistically or otherwise unsuitably broad. Namely, it may be determined if certain signal measurements lack diversity (e.g., RSSI, RTT, etc. decay is abnormally or unsuitably uncharacteristic or slow (e.g., ˜10 dB over 200 ft, etc.), etc.) and may not be representative of or correspond to an expected or “normal” decay of “ground truth” measurements over a certain distance. Here, instead of or in addition to a radio signal propagation threshold discussed above, an erroneous, suspicious, etc. radio heatmap may be detected or flagged via an application of a gradient threshold, for example, accounting for a radio heatmap's expected signal values distribution. For example, at times, one or more variables representing expected signatures may be tested within a signal interpolation framework that specifies spatial correlation within a particular radio heatmap (e.g., characteristic length in Gaussian process regression, etc.). Likewise, a gradient threshold may be determined, at least in part, experimentally and may be pre-defined, for example, or otherwise dynamically defined in some manner depending on a particular environment, radio heatmap, venue, application, or the like.

In an implementation, during an analysis of collected measurements, it may be determined that one or more maximum signal signature values (e.g., maximum RSSIs obtained from an access point, etc.) may be consistently weaker than expected or may be near a so-called noise-floor (e.g., −90 dB, etc.). This may also indicate that an associated radio heatmap may, for example, be prone to lack of diversity in collected measurements, as discussed above, and, as a result, may have an infeasible or uncharacteristic signal spatial correlation, which may introduce uncertainty to crowd-sourced “ground truth” measurements,” pairing measurements with ground truth” locations, or the like. Regarding diversity, if all or most signal measurements in a venue are collected from a particular wireless transmitter with respect to a certain area (e.g., a corridor, wing, etc.), for example, it may be assumed that these measurements may not be sufficiently diverse so as to represent a radio heatmap for such a venue. In such a case, one or more incentives discussed herein may prompt a user to collect measurements from other areas, such as to introduce or improve measurement diversity with respect to that particular wireless transmitter.

At times, uncertainty or unreliability inherent in crowd-sourcing signal measurements may, for example, be detected by examining extreme signal signature values (e.g., maximum RSSI, minimum RTT, etc.) obtained from a known wireless transmitter within a venue, as one possible example. Thus, at times, a radio heatmap may, for example, be flagged as unreliable, suspicious, etc. if extreme signal signature values may be outside of a certain expected signature value threshold (e.g., RSSI is less than expected, RTT is more than expected, etc.). In some instances, such as to ensure or improve signal diversity, a suitable histogram of signal measurements may also be analyzed or examined, for example, and may be compared to some signal base level or benchmark. This may, for example, help to identify or flag a radio heatmap or any a portion thereof as well as one or more associated wireless transmitters that lack sufficient or otherwise suitable signal diversity.

In some instances, such as if an interpolation approach mentioned above may not provide some sufficient or suitable level of predicted uncertainty, for example, a leave-one-out validation method or approach may be used, at least in part, such as to test a probability that an area of measured signal signatures may be suitably represented via an interpolated radio heatmap. For this example, if an average discrepancy between a left-out sample and a radio heatmap generated by utilizing, at least in part, the rest or most of the samples is greater than some threshold, the radio heatmap or a portion thereof may, for example, be flagged as unreliable and identified as a candidate for further data collection. Likewise, here, a sample discrepancy threshold may be determined, at least in part, experimentally and may be pre-defined, for example, or otherwise dynamically defined in some manner depending on a particular environment, radio heatmap, venue, application, or the like. In addition, at times, one or more signal measurements from a particular wireless transmitter may not be observed or “seen” by a proximate mobile device in locations where relatively strong signal measurements were previously detected. This may, for example, indicate that an associated wireless transmitter is frequently turned off or otherwise not working properly, which may prompt the transmitter to be flagged accordingly. Of course, these are merely examples relating to an analysis of collected measurements so as to detect or flag an unreliable, erroneous, suspicious, etc. radio heatmap or associated signal signatures, and claimed subject matter is not limited in these regards.

As was indicated, if one or more inadequate, insufficient, erroneous, suspicious, etc. measurements are identified, such as via an analysis discussed above, for example, a venue operator may selectively provide feedback to one or more agents or users, such as by sending one or more additional messages. As illustrated via an arrow 314 of FIG. 3, in some instances, feedback may be provided via a client-server communication, for example, and may include one or more updated instructions or indications to one or more users 304 to collect new, different, etc. signal measurements. For example, updated instructions or indications may ask or instruct user 304 to commence collecting measurements in a different portion of venue 308, recollect measurements in the same portion of venue 308, change direction of travel while collecting measurements, if applicable or desired, or the like. Likewise, here, one or more updated instructions or indications may comprise, for example, a visual-type instruction or indication, a haptic-type instruction or indication, sound-type instruction or indication, etc., or any combination thereof.

In some instances, one or more updated instructions or indications may also be color-coded, such as to indicate more or less desirable routes or areas for collecting signal measurements, for example. Signal measurements collected in response to feedback comprising one or more updated instructions or indications may, for example, be transmitted by one or more users 304 to server 302 via any suitable client-server communication, as illustrated via an arrow at 316. Based, at least in part, on feedback-related measurements, one or more inadequate, insufficient, erroneous, suspicious, etc. signal signatures may be corrected or updated, such as at server 302, for example, so as to improve or optimize an associated radio heatmap. Thus, feedback to one or more users 304 may facilitate or support indoor positioning, such as via more effective of efficient radio heatmap constructing or updating, for example, as well as more precise pairing or correlation of crowd-sourced measurements with “ground truth” locations within an indoor or like environment, such as venue 308 or any portion thereof.

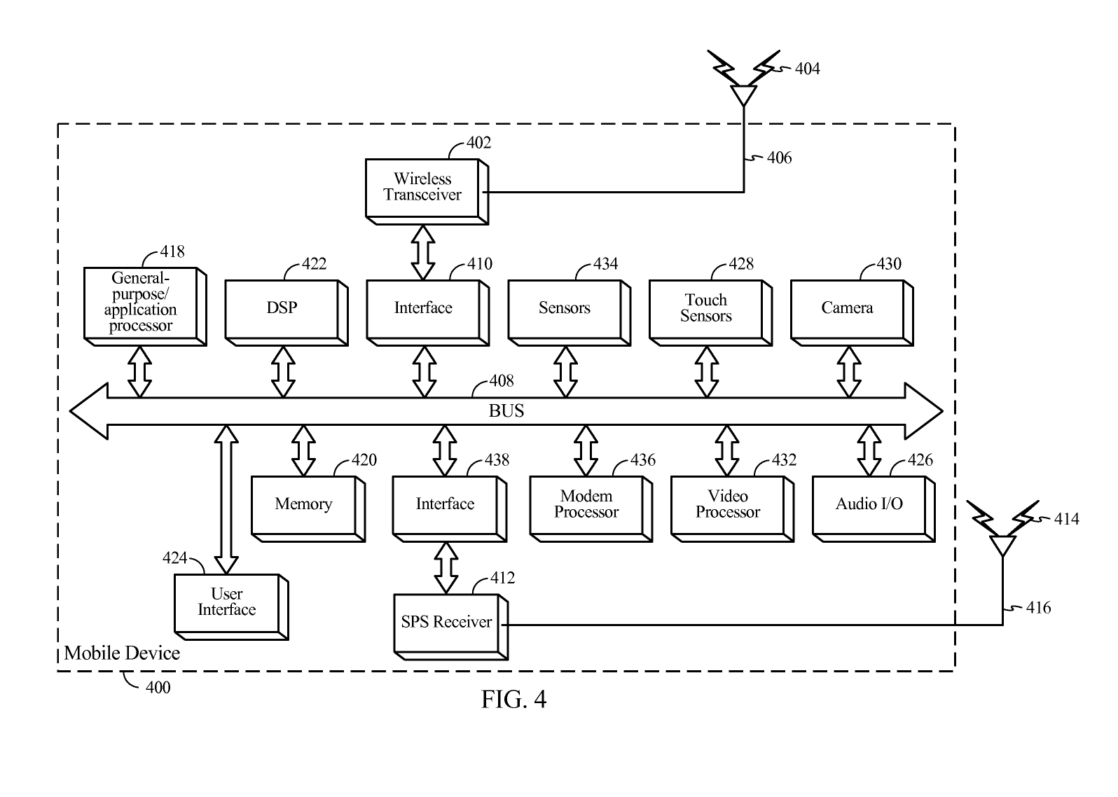

FIG. 4 is a schematic diagram of an implementation of an example computing environment associated with a mobile device that may be used, at least in part, to facilitate or support one or more operations or techniques for improving or optimizing a radio heatmap via feedback to one or more agents. An example computing environment may comprise, for example, a mobile device 400 that may include one or more features or aspects of mobile device 102 of FIG. 1, though claimed subject matter is not so limited. For example, in some instances, mobile device 400 may comprise a wireless transceiver 402 capable of transmitting or receiving wireless signals, referenced generally at 404, such as via an antenna 406 over a suitable wireless communications network. Wireless transceiver 402 may, for example, be capable of sending or receiving one or more suitable communications, such as one or more communications discussed with reference to FIGS. 2-3.

By way of example but not limitation, in some instances, wireless transceiver 402 may comprise, for example, or be representative of means for collecting measurements while traveling over a route or area in a venue, the route or the area being determined according to one or more initial instructions in one or more messages received from a server, such as to implement operation 202 of FIG. 2, at least in part. In addition, in at least one implementation, wireless transceiver 402 may be representative of or comprise, for example, means for transmitting, in response to the one or more initial instructions, one or more messages to the server comprising the collected measurements for use in computing expected signature values at predetermined locations in the venue, such as to implement operation 204 of FIG. 2, at least in part. Also, at times, wireless transceiver 402 may comprise, for example, or be representative of means for receiving one or more messages from the server comprising one or more updated instructions for collecting measurements while traveling in the venue, the one or more updated instructions being determined based, at least in part, on an analysis of the collected measurements determined at the server, as illustrated in or described with respect to operation 206 of FIG. 2, for example. Wireless transceiver 402 may, for example, be coupled or connected to a bus 408 via a wireless transceiver bus interface 410. Depending on an implementation, at times, wireless transceiver bus interface 410 may, for example, be at least partially integrated with wireless transceiver 402. Some implementations may include multiple wireless transceivers 402 or antennas 406 so as to enable transmitting or receiving signals according to a corresponding multiple wireless communication standards such as Wireless Fidelity (WiFi), Code Division Multiple Access (CDMA), Wideband-CDMA (W-CDMA), Long Term Evolution (LTE), Bluetooth®, just to name a few examples.

In an implementation, mobile device 400 may, for example, comprise an SPS or like receiver 412 capable of receiving or acquiring one or more SPS or other suitable wireless signals 414, such as via an SPS or like antenna 416. SPS receiver 412 may process, in whole or in part, one or more acquired SPS signals 414 for estimating a location, coarse or otherwise, of mobile device 400. In some instances, one or more general-purpose application processors 418 (henceforth referred to as “processor”), memory 420, digital signal processor(s) (DSP) 422, or like specialized devices or processors not shown may be utilized to process acquired SPS signals 414, in whole or in part, calculate a location of mobile device 400, such as in conjunction with SPS receiver 412, or the like. Storage of SPS or other signals for implementing one or more positioning operations, such as in connection with one or more techniques for utilizing a mobile device to learn parameters of a radio heatmap, for example, may be performed, at least in part, in memory 420, suitable registers or buffers (not shown). Although not shown, it should be appreciated that in at least one implementation one or more processors 418, memory 420, DSPs 422, or like specialized devices or processors may comprise one or more processing modules capable of collecting measurements while traveling over a route or area in a venue, the route or the area being determined according to one or more initial instructions in one or more messages received from a server; transmitting, in response to the one or more initial instructions, one or more messages to the server comprising the collected measurements for use in computing expected signature values at predetermined locations in the venue; and receiving one or more messages from the server comprising one or more updated instructions for collecting measurements while traveling in the venue, the one or more updated instructions being determined based, at least in part, on an analysis of the collected measurements determined at the server

It should be noted that all or part of one or more processing modules may be implemented using or otherwise including hardware, firmware, software, or any combination thereof. Processing modules may be representative of one or more circuits capable of performing at least a portion of information computing technique or process. By way of example but not limitation, processor 418 or DSP 422 may include one or more processors, controllers, microprocessors, microcontrollers, application specific integrated circuits, digital signal processors, programmable logic devices, field programmable gate arrays, or the like, or any combination thereof. Thus, at times, processor 418 or DSP 322 or any combination thereof may comprise or be representative of means for collecting measurements while traveling over a route or area in a venue, the route or the area being determined according to one or more initial instructions in one or more messages received from a server, such as to implement operation 202 of FIG. 2, at least in part. In addition, in at least one implementation, wireless transceiver 402 may be representative of or comprise, for example, means for transmitting, in response to the one or more initial instructions, one or more messages to the server comprising the collected measurements for use in computing expected signature values at predetermined locations in the venue, such as to implement operation 204 of FIG. 2, at least in part. Also, at times, wireless transceiver 402 may comprise, for example, or be representative of means for receiving one or more messages from the server comprising one or more updated instructions for collecting measurements while traveling in the venue, the one or more updated instructions being determined based, at least in part, on an analysis of the collected measurements determined at the server, as illustrated in or described with respect to operation 206 of FIG. 2, for example.

As illustrated, DSP 422 may be coupled or connected to processor 418 and memory 420 via bus 408. Although not shown, in some instances, bus 408 may comprise one or more bus interfaces that may be integrated with one or more applicable components of mobile device 400, such as DSP 422, processor 418, memory 420, or the like. In various embodiments, one or more operations or functions described herein may be performed in response to execution of one or more machine-readable instructions stored in memory 420, such as on a computer-readable storage medium, such as RAM, ROM, FLASH, disc drive, etc., just to name a few examples. Instructions may, for example, be executable via processor 418, one or more specialized processors not shown, DSP 422, or the like. Memory 420 may comprise a non-transitory processor-readable memory, computer-readable memory, etc. that may store software code (e.g., programming code, instructions, etc.) that may be executable by processor 418, DSP 422, or the like to perform operations or functions described herein.

Mobile device 400 may comprise a user interface 424, which may include any one of several devices such as, for example, a speaker, microphone, display device, vibration device, keyboard, touch screen, etc., just to name a few examples. In at least one implementation, user interface 424 may enable a user to interact with one or more applications hosted on mobile device 400. For example, one or more devices of user interface 424 may store analog or digital signals on memory 420 to be further processed by DSP 422, processor 418, etc. in response to input or action from a user. Similarly, one or more applications hosted on mobile device 400 may store analog or digital signals in memory 420 to present an output signal to a user. In some implementations, mobile device 400 may optionally include a dedicated audio input/output (I/O) device 426 comprising, for example, a dedicated speaker, microphone, digital to analog circuitry, analog to digital circuitry, amplifiers, gain control, or the like. It should be understood, however, that this is merely an example of how audio I/O device 426 may be implemented, and that claimed subject matter is not limited in this respect. As seen, mobile device 400 may comprise one or more touch sensors 428 responsive to touching or like pressure applied on a keyboard, touch screen, or the like.

In an implementation, mobile device 400 may comprise, for example, a camera 440, dedicated or otherwise, such as for capturing still or moving imagery, or the like. Camera 440 may comprise, for example, a camera sensor or like imaging device (e.g., charge coupled device, complementary metal oxide semiconductor (CMOS)-type imager, etc.), lens, analog to digital circuitry, frame buffers, etc., just to name a few examples. In some instances, additional processing, conditioning, encoding, or compression of signals representing one or more captured images may, for example, be performed, at least in part, at processor 418, DSP 422, or the like. Optionally or alternatively, a video processor 432, dedicated or otherwise, may perform conditioning, encoding, compression, or manipulation of signals representing one or more captured images. Additionally, video processor 432 may, for example, decode or decompress one or more stored images for presentation on a display (not shown) of mobile device 400.

Mobile device 400 may comprise one or more sensors 434 coupled or connected to bus 408, such as, for example, one or more inertial sensors, ambient environment sensors, or the like. Inertial sensors of sensors 444 may comprise, for example, one or more accelerometers (e.g., collectively responding to acceleration of mobile device 400 in one, two, or three dimensions, etc.), gyroscopes or magnetometers (e.g., to support one or more compass or like applications, etc.), etc., just to illustrate a few examples. Ambient environment sensors of mobile device 400 may comprise, for example, one or more barometric pressure sensors, temperature sensors, ambient light detectors, camera sensors, microphones, etc., just to name few examples. Sensors 434 may generate analog or digital signals that may be stored in memory 420 and may be processed by DSP 422, processor 418, etc., such as in support of one or more applications directed to positioning or navigation operations, wireless communications, radio heatmap learning, video gaming or the like.

In a particular implementation, mobile device 400 may comprise a modem processor 436, dedicated or otherwise, capable of performing baseband processing of signals received or downconverted via wireless transceiver 402, SPS receiver 412, or the like. Similarly, modem processor 436 may perform baseband processing of signals to be upconverted for transmission via wireless transceiver 402, for example. In alternative implementations, instead of having a dedicated modem processor, baseband processing may be performed, at least in part, by processor 418, DSP 422, or the like. In addition, in some instances, an interface 438, although illustrated as a separate component, may be integrated, in whole or in part, with one or more applicable components of mobile device 400, such as bus 408 or SPS receiver 412, for example. Optionally or alternatively, SPS receiver 412 may be coupled or connected to bus 408 directly. It should be understood, however, that these are merely examples of components or structures that may perform baseband processing, and that claimed subject matter is not limited in this regard.

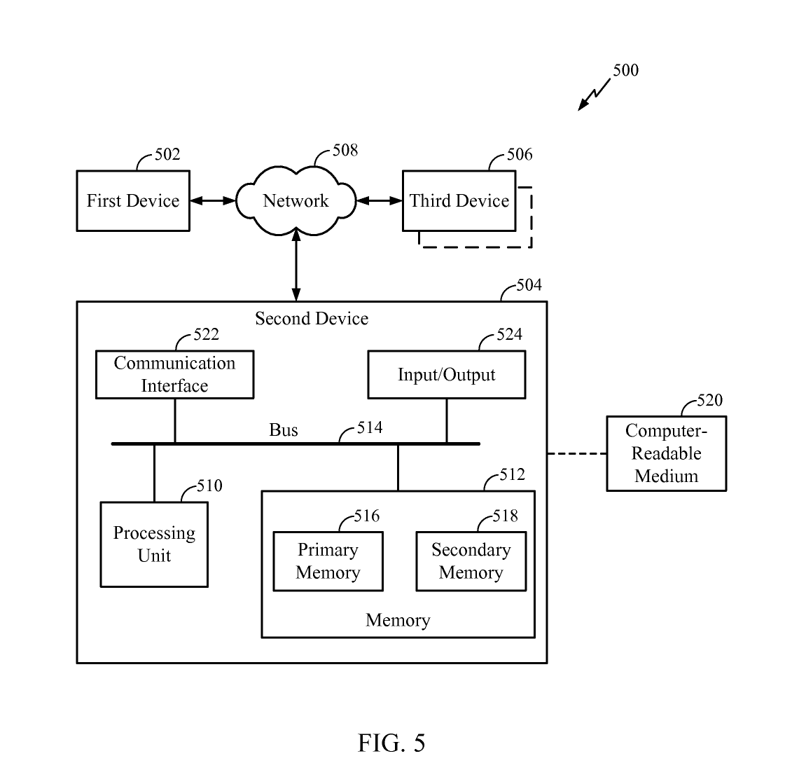

FIG. 5 is a schematic diagram illustrating an implementation of an example computing environment or system 500 that may be associated with or include one or more servers or other devices capable of partially or substantially implementing or supporting one or more operations or techniques for improving or optimizing a radio heatmap via feedback to one or more agents, such as discussed above in connection with FIGS. 1-3, for example. Computing environment 500 may include, for example, a first device 502, a second device 505, a third device 506, etc., which may be operatively coupled together via a communications network 508. In some instances, first device 502 may comprise a server capable of providing positioning assistance data, such as, for example, identities or locations of known wireless transmitters, radio heatmap, base station almanac, electronic digital map, or the like. For example, first device 502 may also comprise a server capable of providing an electronic digital map to a mobile device based, at least in part, on a coarse or rough estimate of a location of the mobile device, upon request, or the like. First device 502 may also comprise a server capable of providing any other suitable indoor positioning assistance data (e.g., an electronic digital map, radio heatmap, etc.), relevant to a location of a mobile device. Second device 505 or third device 506 may comprise, for example, mobile devices, though claimed subject matter is not so limited. For example, in some instances, second device 505 may comprise a server functionally or structurally similar to first device 502, just to illustrate another possible implementation. In addition, communications network 508 may comprise, for example, one or more wireless transmitters, such as access points, femtocells, or the like. Of course, claimed subject matter is not limited in scope in these respects.

First device 502, second device 504, or third device 506 may be representative of any device, appliance, platform, or machine that may be capable of exchanging information over communications network 508. By way of example but not limitation, any of first device 502, second device 504, or third device 506 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 502, 504, and 506, respectively, may comprise one or more of a mobile device, wireless transmitter or receiver, server, etc. in accordance with example implementations described herein.

In an implementation, communications network 508 may be representative of one or more communication links, processes, or resources capable of supporting an exchange of information between at least two of first device 502, second device 504, or third device 506. By way of example but not limitation, communications network 508 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 506, there may be additional like devices operatively coupled to communications network 508. It is also recognized that all or part of various devices or networks shown in computing environment 500, or processes or methods, as described herein, may be implemented using or otherwise including hardware, firmware, software, or any combination thereof.

By way of example but not limitation, second device 504 may include at least one processing unit 510 that may be operatively coupled to a memory 512 via a bus 514. Processing unit 510 may be representative of one or more circuits capable of performing at least a portion of a suitable computing procedure or process. For example, processing unit 510 may include one or more processors, controllers, microprocessors, microcontrollers, application specific integrated circuits, digital signal processors, programmable logic devices, field programmable gate arrays, or the like, or any combination thereof.

Memory 512 may be representative of any information storage mechanism or appliance. Memory 512 may include, for example, a primary memory 516 and a secondary memory 518. Primary memory 516 may include, for example, a random access memory, read only memory, etc. While illustrated in this example as being separate from processing unit 510, it should be understood that all or part of primary memory 516 may be provided within or otherwise co-located/coupled with processing unit 510. Secondary memory 518 may include, for example, same or similar type of memory as primary memory or one or more information storage devices or systems, such as, for example, a disk drive, an optical disc drive, a tape drive, a solid state memory drive, etc. In certain implementations, secondary memory 518 may be operatively receptive of, or otherwise configurable to couple to, a computer-readable medium 520. Computer-readable medium 520 may include, for example, any non-transitory storage medium that may carry or make accessible information, code, or instructions for one or more of devices in computing environment 500. Computer-readable medium 520 may also be referred to as a storage medium.

Second device 504 may include, for example, a communication interface 522 that may provide for or otherwise support an operative coupling of second device 504 to at least communications network 508. By way of example but not limitation, communication interface 522 may include a network interface device or card, a modem, a router, a switch, a transceiver, and the like. Second device 504 may also include, for example, an input/output device 524. Input/output device 524 may be representative of one or more devices or features that may be configurable to accept or otherwise introduce human or machine inputs, or one or more devices or features that may be capable of delivering or otherwise providing for human or machine outputs. By way of example but not limitation, input/output device 524 may include an operatively configured display, speaker, keyboard, mouse, trackball, touch screen, information port, or the like.

Methodologies described herein may be implemented by various means depending upon applications according to particular features or examples. For example, methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, methodologies may be implemented with modules (e.g., procedures, functions, etc.) having instructions that perform functions described herein. Any computer-readable medium tangibly embodying instructions may be used in implementing methodologies described herein. For example, software codes may be stored in a memory and executed by a processor. Memory may be implemented within the processor or external to the processor. As used herein the term “memory” may refer to any type of long term, short term, volatile, non-volatile, or other memory and is not to be limited to any particular type of memory or number of memories, or type of media upon which memory is stored. In at least some implementations, one or more portions of the herein described storage media may store signals representative of information as expressed by a particular state of the storage media. For example, an electronic signal representative of information may be “stored” in a portion of the storage media (e.g., memory) by affecting or changing the state of such portions of the storage media to represent information as binary information (e.g., via ones and zeros). As such, in a particular implementation, such a change of state of the portion of the storage media to store a signal representative of information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to store desired program code in the form of instructions or information structures and that may be accessed by a computer or processor thereof. Disk and disc, as used herein, includes compact disc (CD), laser disc, optical disc, digital versatile disc (DVD), floppy disk and blue-ray disc where disks usually reproduce information magnetically, while discs reproduce information optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN),a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2”(3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In an implementation, a mobile device may, for example, be capable of communicating with one or more femtocells, such as for the purpose of estimating its location, obtaining positioning assistance data, extending cellular telephone service into a business or home, or the like. As used herein, “femtocell” may refer to one or more smaller-size cellular base stations that may be capable of detecting a wireless signal transmitted from a mobile device using one or more appropriate techniques. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA)-2000, or Time Division Synchronous Code Division Multiple Access (TD-SCDMA), to name just a few examples among many possible. In certain implementations, a femtocell may comprise integrated WiFi, for example, and may provide a mobile device access to a larger cellular telecommunication network by way of another broadband network, such as the Internet. However, such details relating to femtocells are merely examples, and claimed subject matter is not so limited.

Techniques described herein may be used with an SPS that includes any one of several GNSS or combinations of GNSS. Furthermore, techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal, etc.). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “space vehicle” (SV), as used herein, is intended to include terrestrial transmitters acting as pseudolites, equivalents of pseudolites, and possibly others. The terms “SPS signals” or “SV signals”, as used herein, is intended to include SPS-like signals from terrestrial transmitters, including terrestrial transmitters acting as pseudolites or equivalents of pseudolites.

Also, computer-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media. Such computer instructions may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
collecting, at a mobile device, measurements while traveling over a route or area in a venue, said route or said area being determined according to one or more initial instructions in one or more messages received from a server;
transmitting, in response to said one or more initial instructions, one or more messages to said server comprising said collected measurements for use in computing expected signature values at predetermined locations in said venue; and
receiving one or more messages from said server comprising one or more updated instructions for collecting measurements while traveling in said venue, said one or more updated instructions being determined based, at least in part, on an analysis of said collected measurements determined at said server.

2. The method of claim 1, wherein said one or more initial instructions and said one or more updated instructions are color-coded to specify at least one of the following: a direction of travel; a path or trajectory of travel; said route; said area; a level of a reward; or any combination thereof.

3. The method of claim 1, wherein said expected signature values at said predetermined locations in said venue are used, at least in part, to generate a radio heatmap for said venue.

4. The method of claim 1, and further comprising transmitting, in response to said one or more updated instructions, one or more messages to said server comprising collected feedback-related measurements for use in one or more of computing and updating said expected signature values at said predetermined locations in said venue.

5. The method of claim 1, wherein said analysis of said collected measurements comprises at least one of the following: a clustering-type analysis; a spatial correlation-type analysis; diversity-type analysis; a leave-one-out validation-type analysis; or any combination thereof.

6. The method of claim 1, wherein said one or more initial instructions and said one or more updated instructions comprise at least one of the following: a visual-type instruction; a haptic-type instruction; a sound-type instruction; or any combination thereof.

7. The method of claim 1, wherein said one or more initial instructions and said one or more updated instructions are provided in connection with a displayable electronic digital map for at least one of the following: said route; said area; said venue; or any combination thereof.

8. The method of claim 1, wherein said one or more initial instructions and said one or more updated instructions are provided via a user interface of said mobile device.

9. The method of claim 1, wherein said one or more messages transmitted to said server comprise said collected measurements paired with “ground truth” locations in said venue.

10. The method of claim 1, wherein said expected signature values at said predetermined locations in said venue comprise at least one of the following: RSSI values; RTT values; or any combination thereof.

11. The method of claim 1, and further comprising providing a reward based, at least in part, on a completion of a task according to at least one of the following: said one or more initial instructions; said one or more updated instructions; or any combination thereof.

12. The method of claim 11, wherein said reward comprises at least one of the following: a monetary reward; a non-monetary reward; or any combination thereof.

13. An apparatus comprising:
a mobile device comprising:
a wireless transceiver to communicate with a server via an electronic communications network; and
one or more processors to:
collect measurements while traveling over a route or area in a venue, said route or said area being determined according to one or more initial instructions in one or more messages received from said server;
transmit, in response to said one or more initial instructions, one or more messages to said server comprising said collected measurements for use in computing expected signature values at predetermined locations in said venue; and
receive one or more messages from said server comprising one or more updated instructions for collecting measurements while traveling in said venue, said one or more updated instructions being determined based, at least in part, on an analysis of said collected measurements determined at said server.

14. The apparatus of claim 13, wherein said one or more messages transmitted to said server comprise said collected measurements paired with “ground truth” locations in said venue.

15. The apparatus of claim 13, wherein said one or more initial instructions and said one or more updated instructions comprises at least one of the following: a visual-type instruction; a haptic-type instruction; a sound-type instruction; or any combination thereof.

16. The apparatus of claim 13, wherein said one or more initial instructions and said one or more updated instructions are provided in connection with a displayable electronic digital map for at least one of the following: said route; said area; said venue; or any combination thereof.

17. The apparatus of claim 13, wherein said one or more initial instructions and said one or more updated instructions are provided via a user interface of said mobile device.

18. The apparatus of claim 13, wherein said expected signature values at said predetermined locations in said venue are used, at least in part, to generate a radio heatmap for said venue.

19. The apparatus of claim 13, wherein said one or more processors further to transmit, in response to said one or more updated instructions, one or more messages to said server, said one or more messages to comprise collected feedback-related measurements for use in one or more of computing and updating said expected signature values at said predetermined locations in said venue.

20. An article comprising:
a non-transitory storage medium having instructions executable by a processor to:
collect, at a mobile device, measurements while traveling over a route or area in a venue, said route or said area being determined according to one or more initial instructions in one or more messages received from a server;
initiate transmission, in response to said one or more initial instructions, one or more messages to said server comprising said collected measurements for use in computing expected signature values at predetermined locations in said venue; and
receive one or more messages from said server comprising one or more updated instructions for collecting measurements while traveling in said venue, said one or more updated instructions being determined based, at least in part, on an analysis of said collected measurements determined at said server.
